(19) United States
(12) Patent Application Publication
(10) Pub. No.: US 2026/0208513 A1
(43) Pub. Date: Jul. 23, 2026

(54) PRINTER

(71) Applicant: Toshiba Tec Kabushiki Kaisha, Tokyo (JP)

(72) Inventor: Tsuyoshi SANADA, Susono Shizuoka (JP)

(21) Appl. No.: 19/358,360

(22) Filed: Oct. 14, 2025

(30) Foreign Application Priority Data
Jan. 22, 2025 (JP) 2025-008828

(51) Int. Cl. B41J 15/02; B41J 15/04

(52) U.S. Cl. CPC B41J 15/02; B41J 15/046

(57) ABSTRACT

A printer includes a holder that holds a sheet roll in a tilted position; a printing unit that conveys a sheet from the sheet roll and performs printing on the conveyed sheet; a damper that is provided between the holder and the printing unit to reduce an impact caused by a variation in a conveying force for conveying the sheet; and a sheet guide that guides the sheet from the holder to the damper and adjusts the length of a conveyance path of the sheet between the holder and the damper.

### CROSS-REFERENCE TO RELATED APPLICATION

This application is based upon and claims the benefit of priority from Japanese Patent Application No. 2025-008828, filed Jan. 22, 2025, the entire contents of which are incorporated herein by reference.

### FIELD

Embodiments described herein relate generally to a printer.

### BACKGROUND

In a printer that holds a sheet roll formed by winding a strip-shaped sheet and feeds the sheet from the sheet roll to perform printing, a retaining member is often provided to determine the width direction position of the sheet roll. In contrast to such a general structure, there is a technical idea that eliminates the need for the retaining member by holding a sheet roll sheet in a tilted position.

When the roll sheet is held in a tilted position, the subsequent sheet path also needs to be tilted, which results in an increased printer size. Also, when a thermal head and a platen roller are not tilted, the tilt of the sheet must be eliminated in the sheet path to the printing position.

Accordingly, to achieve effects, such as the reduction in the number of components, the reduction in costs, and easy sheet roll loading, by holding a sheet roll in a tilted position and eliminating the need for a retaining member, a printer needs to have a configuration for correcting the tilt of a sheet before the sheet reaches a printing position.

### SUMMARY OF THE INVENTION

Embodiments of this disclosure provide a printer capable of correcting the tilt of a sheet that is fed from a sheet roll held in a tilted position before the sheet reaches a printing position.

According to an aspect of this disclosure, a printer includes a holder that holds a sheet roll in a tilted position; a printing unit that conveys a sheet from the sheet roll and performs printing on the conveyed sheet; a damper that is provided between the holder and the printing unit to reduce an impact caused by a variation in a conveying force for conveying the sheet; and a sheet guide that guides the sheet from the holder to the damper and adjusts the length of a conveyance path of the sheet between the holder and the damper.

### BRIEF DESCRIPTION OF THE DRAWINGS

FIG. 1 is a schematic diagram illustrating an example of a structure of a printer according to a first embodiment.

FIG. 2 is a schematic diagram illustrating an example of a structure of the printer according to the first embodiment.

FIG. 3 is a schematic diagram illustrating an example of a structure of the printer according to the first embodiment.

FIG. 4 is a schematic diagram illustrating an example of a structure of a printer according to a second embodiment.

### DETAILED DESCRIPTION

### First Embodiment

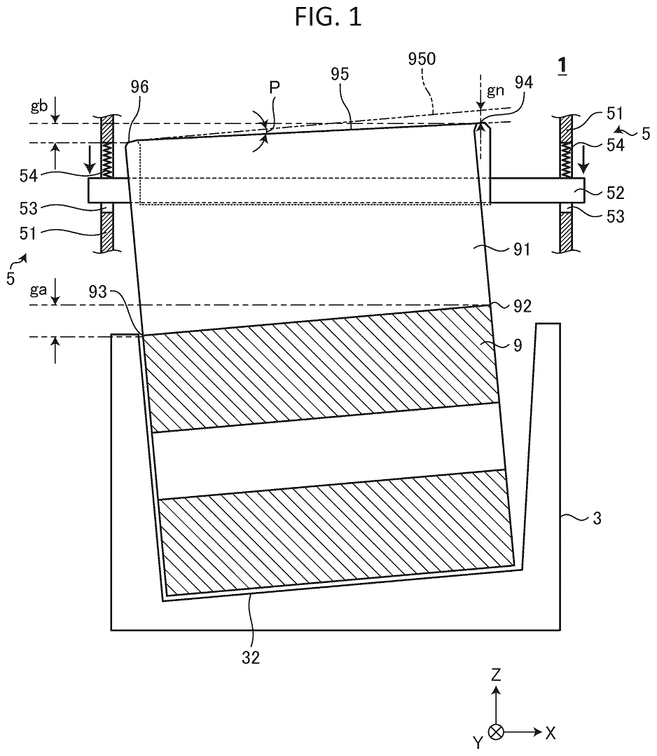

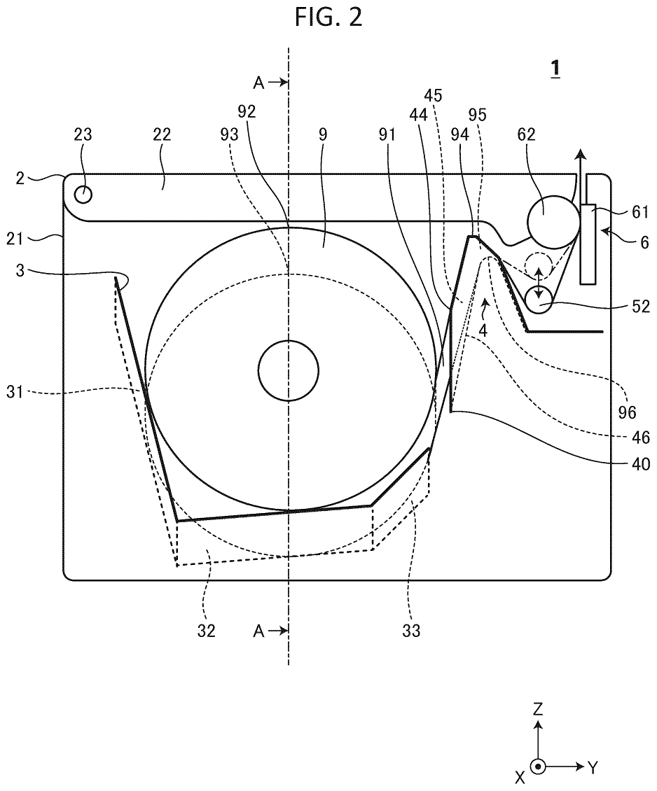

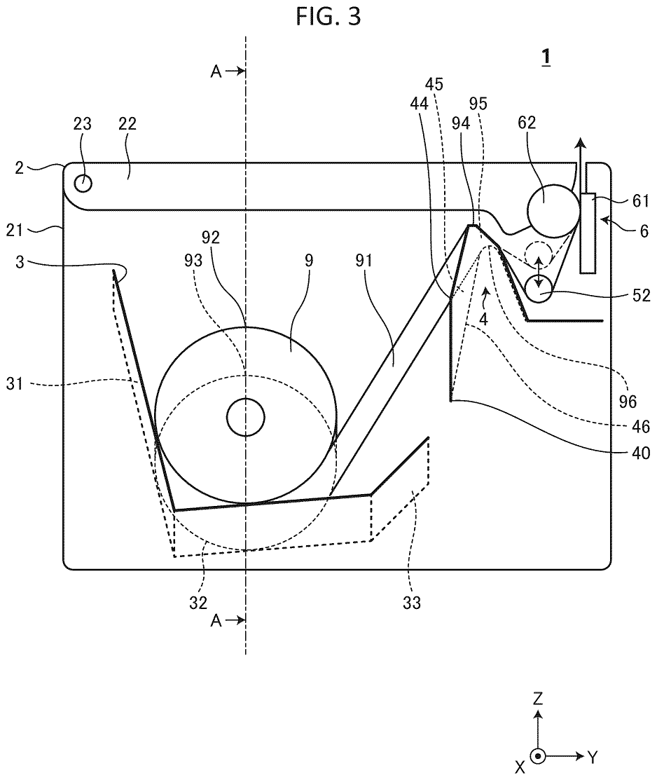

A first embodiment will be described with reference to the drawings. FIGS. 1 to 3 are schematic diagrams illustrating an example of a structure of a printer 1 according to the first embodiment. For convenience of explanation, a three dimensional coordinate system is shown in the drawings. The X-axis direction is the width direction (or right-left direction) of the printer 1 and a sheet roll 9. The Y-axis direction is the depth direction (or front-back direction) of the printer 1. The Z-axis direction is a height direction (or up-down direction) of the printer 1. FIG. 1 is a cross-sectional view taken along line A-A shown in FIGS. 2 and 3.

The depth direction in FIG. 1 corresponds to the depth direction (or Y-axis direction) of the printer 1. The right side of the printer 1 corresponds to the right side of FIG. 1, and the left side of the printer 1 corresponds to the left side of FIG. 1. The positive X-axis direction is a direction from the left side to the right side.

The depth direction in FIGS. 2 and 3 corresponds to the width direction (or X-axis direction) of the printer 1 and the sheet roll 9. The sheet roll 9 in FIG. 2 is at full diameter, and the sheet roll 9 in FIG. 3 is at reduced diameter.

In the descriptions of the present embodiment, terms such as front, back, left, and right may be used to indicate the sides or the orientation of the printer 1. However, these terms are used merely for descriptive purposes and are not intended to limit the scope of this disclosure.

The printer 1 includes a housing 2, a sheet holder 3, an adjuster 4, a damper 5, a printing unit 6, and the like. The housing 2 is a box-shaped container including a main body 21, a lid 22, and a hinge 23 and houses the sheet holder 3, the adjuster 4, the damper 5, the printing unit 6, and the like.

The main body 21 has a box shape with an opening. The lid 22 is configured to be movable between a position at which the opening of the main body 21 is closed and a position at which the opening of the main body 21 is opened, and is moved to open and close the opening of the main body 21. The hinge 23 rotatably connects a portion of the lid 22 to a portion of an edge of the main body 21. The lid 22 is movable (or rotatable) with respect to the main body 21, and the opening of the main body 21 is opened and closed according to the movement (or rotation).

The sheet roll 9 is a roll of a strip-shaped sheet 91. The sheet holder 3 is a space between the main body 21 and the lid 22 and rotatably holds the sheet roll 9. The sheet holder 3 is an example of a holder. The sheet roll 9 rotates when the sheet 91 is fed. The sheet 91 is conveyed by the printing unit 6 downstream in the conveyance direction.

The sheet holder 3 has a surface that supports the outer peripheral surface of the sheet roll 9. The surface is inclined along a direction in which the distance between the surface and the lid 22 varies and is also inclined such that the distance between the surface and the printing unit 6 varies along the width direction of the sheet roll 9.

The sheet holder 3 is a so-called drop-in holder and is a substantially U-shaped recess that is inclined along the width direction (or X-axis direction) of the printer 1. The sheet roll 9 is placed into the recess and is held in a tilted position. When the sheet roll 9 is placed into the recess of the sheet holder 3, which is inclined along the width direction, the outer circumferential surface of the sheet roll 9 contacts the inner surfaces of the recess, and the sheet roll 9 is tilted along the shape of the recess. The sheet roll 9 is tilted such that the right side of the sheet roll 9 is higher than the left side in FIG. 1, and the front side of the sheet roll 9 is higher than the back side in FIGS. 2 and 3. In other words, the sheet roll 9 held by the sheet holder 3 in the tilted position has a higher side and a lower side. The adjuster 4 is disposed to extend the recess downstream in the sheet conveyance direction.

The recess has multiple bottom surfaces 31, 32, and 33. The bottom surfaces 31, 32, and 33 are examples of bottom surfaces that are inclined along the depth direction of the recess and are also inclined in the width direction of the printer 1. Each of the bottom surfaces 31, 32, and 33 is inclined such that its right side is higher than its left side in FIG. 1, and its front side is higher than its back side in FIGS. 2 and 3.

The printing unit 6 includes a thermal head 61 and a platen roller 62. The thermal head 61 includes a plurality of heating elements arranged linearly along the width direction. The thermal head 61 is an example of a print head. The platen roller 62 rotates and thereby conveys the sheet 91 sandwiched between the platen roller 62 and the heating elements. The platen roller 62 is an example of a roller. The printing unit 6 prints information on the sheet 91 by selectively driving the heating elements while conveying the sheet 91.

The damper 5 is an example of a damper that is provided between the sheet holder 3 and the printing unit 6 to reduce an impact caused by a variation in the conveying force for conveying the sheet 91. The damper 5 is provided between the sheet holder 3 and the printing unit 6 to reduce the conveyance resistance that is generated when the sheet roll 9 starts to rotate as a result of the conveyance of the sheet 91. That is, when the force required to convey the sheet 91 is large, the damper 5 reduces the tension of the sheet 91.

An example of a structure of the damper 5 is described below. The damper 5 includes a pair of side walls 51, a rod 52, and a pair of elastic members 54.

The rod 52 is an example of a rod around which the sheet 91 is wound. The rod 52 supports (or guides) the sheet 91 such that the height difference between the rod 52 and the bottom surface 32 of the sheet holder 3 is variable at both sides in the width direction of the sheet 91. The rod 52 also changes the conveyance direction of the sheet 91 from downward to upward.

The elastic members 54 are disposed in slits 53 formed in the side walls 51 to bias the rod 52. The elastic members 54 are examples of biasing members. Each slit 53 is long in the vertical direction, and the dimension of the slit 53 in the lateral direction is slightly greater than the diameter of the rod 52.

The rod 52 is supported at both ends by the slits 53. The ends of the rod 52 are slidable in the vertical direction in the slits 53 and are biased downward by the elastic members 54.

With this structure, the rod 52 slides in the vertical direction according to the tension of the sheet 91 while being allowed to slightly roll around the Y-axis and being kept substantially parallel to the X-axis.

The adjuster 4 (hereinafter also referred to as the sheet guide) guides the sheet 91 from the sheet holder 3 to the damper 5 and adjusts the length of the conveyance path (hereafter referred to as “conveyance path length”) of the sheet 91 in a predetermined section (or between the sheet holder 3 and the damper 5). The adjuster 4 adjusts the conveyance path length depending on the position across the width of the sheet 91. More specifically, the adjuster 4 makes the conveyance path length of a portion of the sheet 91 corresponding to the higher side of the sheet roll 9 longer than the conveyance path length of a portion of the sheet 91 corresponding to the lower side of the sheet roll 9.

The adjuster 4 is located between the sheet holder 3 and the damper 5 and protrudes upward in the height direction. The conveyance path of the sheet 91 from the sheet holder 3 to the damper 5 is bent upward in a peak shape by the adjuster 4.

The top part of the adjuster 4 is an example of a bending part that protrudes away from the bottom of the sheet holder 3 and bends the conveyance path of the sheet 91 at a position between the sheet holder 3 and the damper 5. More specifically, the top part of the adjuster 4 has a substantially straight shape and is inclined such that the right side of the top part is higher than the left side. In other words, the top part is inclined such that a portion of the top part (or bending part) corresponding to the higher side of the sheet roll 9 is higher than a portion of the top part (or bending part) corresponding to the lower side of the sheet roll 9. The top part of the adjuster 4 changes the conveyance direction of the sheet 91 from upward to downward. A bent part 95 of the sheet 91 is substantially straight along the top part of the adjuster 4.

Here, if the adjuster 4 guides the sheet 91 only with the top part, the top part of the adjuster 4 needs to be inclined at the same inclination as the inclination of the sheet roll 9 to prevent the discrepancy between the conveyor path lengths of the right and left sides of the sheet 91 between the sheet holder 3 and the damper 5. However, this makes it necessary to increase the height of the top part of the adjuster 4, which results in an increase in the size of the housing 2.

For the above reason, in the printer 1 of the present embodiment, a surface of the adjuster 4 upstream of the top part in the conveyance direction is also configured to push the sheet 91 upward so that the conveyance path length of the higher side (or right side) of the sheet 91 is longer than the conveyance path length of the lower side (or left side). Details of this configuration are described below. The “surface of the adjuster 4 upstream of the top part” indicates a surface located lower than the top part of the adjuster 4 and corresponds to a slope 45 (see FIGS. 2 and 3) described below.

A right edge 44 and a left edge 46 (see FIGS. 2 and 3) of the contour of the slope 45 have different shapes. Specifically, the left edge 46 is a straight oblique line, whereas the right edge 44 is a curved line that bulges substantially in the negative Y-axis direction when viewed from a direction along the width direction of the printer 1 (or the direction shown in FIGS. 2 and 3). Accordingly, the slope 45 between the right edge 44 and the left edge 46 is a curved surface.

The slope 45 is an example of a support surface that supports the sheet 91 between the sheet holder 3 and the top part (or the bending part) of the adjuster 4. A portion of the slope 45 corresponding to the higher side of the sheet roll 9 protrudes relative to a portion of the slope 45 corresponding to the lower side of the sheet roll 9.

Guiding the sheet 91 with the slope 45 makes it possible to vary the lengths of the right and left sides of the sheet 91 from the sheet roll 9 to the top part of the adjuster 4. In the present embodiment, the right side of the sheet 91 is made longer than the left side of the sheet 91.

With the above-described configuration, a height difference gb between a right edge 94 (or first lateral edge) and a left edge 96 (or a second lateral edge) of the sheet 91 at the top part of the adjuster 4 can be made smaller than a height difference ga between a right edge 92 (or first lateral edge) and a left edge 93 (or a second lateral edge) of the sheet roll 9 held by the sheet holder 3 in the tilted position.

A dash-dot-dot line 950 above the top part of the adjuster 4 in FIG. 1 represents the inclination of the sheet roll 9. The inclination of the bent part 95 of the sheet 91 is less than the inclination of the dash-dot-dot line 950 by an angle P. A height difference gn between the right edge 94 of the sheet 91 at the top part of the adjuster 4 and the dash-dot-dot line 950 is equal to the difference between the height difference ga and the height difference gb.

Here, the sheet holder 3 has the lowest corner between the bottom surface 31 and the bottom surface 32. Therefore, when the diameter of the sheet roll 9 decreases as shown in FIG. 3, the sheet roll 9 moves in the negative Y-axis direction. In this state, the conveyance path of the sheet 91 moves away from the slope 45 of the adjuster 4, and the slope 45 may not be able to sufficiently adjust the right and left conveyance path lengths of the sheet 91. However, when the diameter of the sheet roll 9 decreases to such an extent that the sheet 91 moves away from the slope 45, because the weight of the sheet roll 9 also decreases, the insufficient adjustment of the right and left conveyance path lengths can be compensated for by the movement of the rod 52 of the damper 5.

As described above, according to the first embodiment, it is possible to provide the printer 1 capable of correcting the inclination of the sheet 91 fed from the sheet roll 9 held in a tilted position before the sheet 91 reaches the printing position.

The above-described embodiment can be modified and implemented as appropriate by changing a part of the configuration or the functions of each of the above-described devices. Next, a variation of the above-described embodiment will be described as another embodiment. Below, features of the variation that are different from the above-described embodiment will be mainly described. The same reference numbers are used for components common to the above embodiment and the variation, and detailed descriptions of those components will be omitted. The embodiments may be implemented individually or in combination as appropriate.

### Second Embodiment

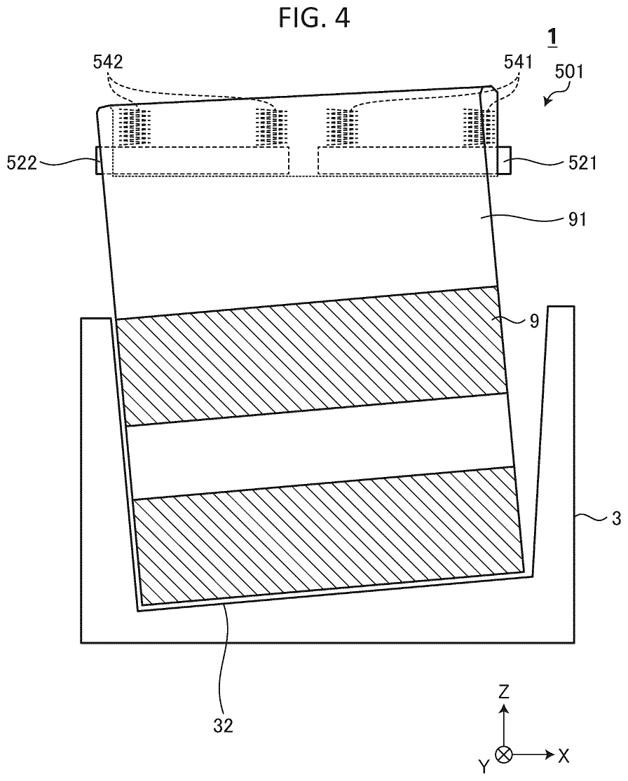

FIG. 4 is a schematic diagram schematically illustrating an example of a structure of a printer 1 according to a second embodiment. In the present embodiment, a damper 501 is provided instead of the damper 5 in the first embodiment.

The damper 501 includes a pair of rods 521 and 522 (or first and second rods) around which the sheet 91 is wound, biasing members 541 (or first biasing member) that bias the rod 521 downward, and biasing members 542 (or second biasing member) that bias the rod 522 downward.

With this configuration, the rods 521 and 522 are movable individually.

When the rods 521 and 522 that press the sheet 91 are provided separately for the right and left sides of the sheet 91, the conveyance path lengths of the right and left sides of the sheet 91 can be easily adjusted. This in turn makes it possible to increase the flexibility in adjusting the conveyance path lengths of the right and left sides of the sheet 91 using the slope 45.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a holder that holds a sheet roll in a tilted position;
a printing unit that conveys a sheet from the sheet roll and performs printing on the conveyed sheet;
a damper that is provided between the holder and the printing unit to reduce an impact caused by a variation in a conveying force for conveying the sheet; and
a sheet guide that guides the sheet from the holder to the damper and adjusts a length of a conveyance path of the sheet between the holder and the damper.

2. The printer according to claim 1, wherein the sheet guide adjusts the length of the conveyance path depending on a position across a width of the sheet.

3. The printer according to claim 2, wherein
the sheet roll held by the holder in the tilted position has a higher side and a lower side; and
the sheet guide makes the length of the conveyance path of a portion of the sheet corresponding to the higher side of the sheet roll longer than the length of the conveyance path of a portion of the sheet corresponding to the lower side of the sheet roll.

4. The printer according to claim 1, wherein the sheet guide includes a bending part that protrudes away from a bottom of the holder and bends the conveyance path of the sheet at a position between the holder and the damper.

5. The printer according to claim 4, wherein the sheet guide makes a height difference between a first lateral edge and a second lateral edge of the sheet at the bending part smaller than a height difference between a first lateral edge and a second lateral edge of the sheet roll held by the holder in the tilted position.

6. The printer according to claim 4, wherein the bending part changes a conveyance direction of the sheet from upward to downward.

7. The printer according to claim 4, wherein
the sheet roll held by the holder in the tilted position has a higher side and a lower side; and
the bending part has a substantially straight shape and is inclined such that a portion of the bending part corresponding to the higher side of the sheet roll is higher than a portion of the bending part corresponding to the lower side of the sheet roll.

8. The printer according to claim 7, wherein
the sheet guide further includes a support surface that supports the sheet between the holder and the bending part; and
a portion of the support surface corresponding to the higher side of the sheet roll protrudes relative to a portion of the support surface corresponding to the lower side of the sheet roll.

9. The printer according to claim 8, wherein the support surface is located lower than the bending part.

10. The printer according to claim 8, wherein the support surface is a curved surface.

11. The printer according to claim 1, wherein
the damper includes a rod around which the sheet is wound and biasing members that bias the rod; and
the rod guides the sheet such that a height difference between the rod and a bottom surface of the holder is variable at both sides in a width direction of the sheet.

12. The printer according to claim 11, wherein the rod changes a conveyance direction of the sheet from downward to upward.

13. The printer according to claim 11, wherein
the damper further includes a pair of side walls having slits formed therein; and
the biasing members are disposed in the slits.

14. The printer according to claim 13, wherein
the rod is supported at both ends by the slits; and
the ends of the rod are slidable in a vertical direction in the slits and are biased downward by the biasing members.

15. The printer according to claim 14, wherein
each of the slits is long in the vertical direction; and
a dimension of the slit in a lateral direction is greater than a diameter of the rod.

16. The printer according to claim 1, wherein the damper includes a first rod and a second rod around which the sheet is wound, a first biasing member that biases the first rod downward, and a second biasing member that biases the second rod downward.

17. The printer according to claim 1, wherein the holder has a surface that supports an outer peripheral surface of the sheet roll and is inclined such that a distance between the surface and the printing unit varies along a width direction of the sheet roll.

18. The printer according to claim 1, wherein the holder is a recess with a substantially U-shape.

19. The printer according to claim 18, wherein the recess has multiple bottom surfaces that are inclined along a depth direction of the recess and are also inclined along a width direction of the printer.

20. The printer according to claim 1, wherein the printing unit includes a roller that conveys the sheet and a print head that performs printing on the conveyed sheet.
